(19) United States
(12) Patent Application Publication
(10) Pub. No.: US 2015/0120519 A1
(43) Pub. Date: Apr. 30, 2015

(54) SYSTEM FOR ESTIMATING PROPERTY TAXES

(71) Applicant: Black Knight IP Holding Company LLC, Jacksonville, FL (US)

(72) Inventors: Mark Collins, Altadena, CA (US); David Talley, Mission Viejo, CA (US); Robert T. Smith, Plano, TX (US)

(21) Appl. No.: 14/525,591

(22) Filed: Oct. 28, 2014

Related U.S. Application Data
(60) Provisional application No. 61/896,285, filed on Oct. 28, 2013.

(51) Int. Cl. G06Q 40/00

(52) U.S. Cl. CPC G06Q 40/10
USPC 705/30

(57) ABSTRACT

A system for more accurately predicting future property tax payments for real estate property, the system including a computer controlling a network to collect the data, the computer configured and programmed to classify the property tax data from previous property tax levies into variable, fixed, and one-time predicted future tax levies based on classification rules. The system then considers the variable, fixed, and one-time tax levies to calculate future tax levies.

### REFERENCE TO RELATED APPLICATION

This application claims priority from U.S. Provisional Patent Application 61/896,285, filed Oct. 28, 2013, which is hereby incorporated by reference.

### BACKGROUND

Applicable property tax assessments can fluctuate from year to year as property value assessments are performed, new taxes are enacted, or other similar changes are made by various taxing authorities. In some places, there are legal limits on how much assessments can change from one year to the next. In California, for example, Proposition 13 is a state law that limits the rate of increase for assessed value of real estate to less than two percent (2%) a year regardless of the rate of increase in market value. This two percent cap on the increase of the assessed value of the property remains in place except when certain triggering events occur such as a transfer of ownership or a significant remodel of an existing property. When the triggering event takes place, the property can be reassessed at current market values which may result in a significant increase in property tax bill amounts.

Triggering events may not be the only cause of significant changes in property tax bill amounts. Besides the ever present possibility that new taxes may be levied, existing provisions may result in unexpected tax increases. For example, under Proposition 8, California law allows a property's assessed value to decrease when the market value is less than the assessed value. However, once real estate values begin to rise, the assessed value can increase more than two percent a year until it reaches the value before the decrease. Thus even without a triggering event a current property owner may be subject to significant uncertainty with respect to future property tax bill amounts.

Accurately estimating whether and to what extent future property tax bill amounts will increase or decrease can be of particular interest to property purchasers and owners, as well as banks and mortgage companies. Mortgage companies and banks, for example, can find it difficult to evaluate risk in property transactions when it is unclear whether the purchaser will see a significant, and perhaps unmanageable, increase in their property tax bill amounts. Likewise, prospective owners can be discouraged from purchasing property without the ability to accurately estimate their future tax obligations over the short or long term. Current property owners can also suffer financially if property taxes fluctuate unexpectedly. The result is significant unpredictability in property ownership and mortgage transactions creating additional risk that is undesirable for all parties involved.

### SUMMARY

Disclosed is a computer implemented property tax estimation system for more accurately calculating expected property tax bill amounts. The system estimates upcoming property tax bill amounts in advance of the payment due dates using previous tax bill amount information and newly obtained or estimated property values such as a purchase price or a recent assessment. Included in the disclosed process are procedures for identifying one or mote taxing agencies or authorities, identifying the relevant aggregate tax information, and collecting detailed tax levy information. Also disclosed are processes for categorizing the detailed tax info data into variable tax levies which may be based on the value of the real estate, fixed levies which may be independent of real estate value, and one-time tax levies which may be related to specific local ordinances, individual properties, properties zoned for a particular use, or other charges or assessments associated with the property which do not appear on an ongoing basis.

Optionally, the system can also determine a mortgage loan or cash payment strategy for increasing or decreasing accrued balances to prepare for upcoming tax bill amounts. For example, the payment strategy may be used to accrue an escrowed property tax fund balance to meet a projected property tax balance due. In another example, the payment strategy may be used to adjust budgetary priorities or spread savings installments across the intervening months leading up to the projected tax bill amount due date to better anticipate a tax bill amount.

Also disclosed is an example of a tax estimate report generated by the system which may be used by the home owner, investor, bank, or mortgage company for record keeping or for creating or changing a current payment schedule according to the projected property tax amounts.

This summary is provided to introduce a selection of concepts in a simplified form that are described in further detail in the detailed description and drawings contained herein. This summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 illustrates an example of a sequence of actions taken by one embodiment of the system.

FIG. 2 illustrates further detail for the act of calculating estimated taxes shown in FIG. 1.

FIG. 3 illustrates further detail for the act of calculating tax estimates shown in FIG. 2.

FIG. 4 illustrates one example of a report that can be generated in the sequence of actions illustrated in FIG. 1

FIG. 5 illustrates further detail for one example of a network within which the system of FIG. 1 can operate.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the claims is thereby intended, such alterations and further modifications in the illustrated device, and such further applications of the principles of the disclosure as illustrated therein, being contemplated as would normally occur to one skilled in the art to which the disclosure relates.

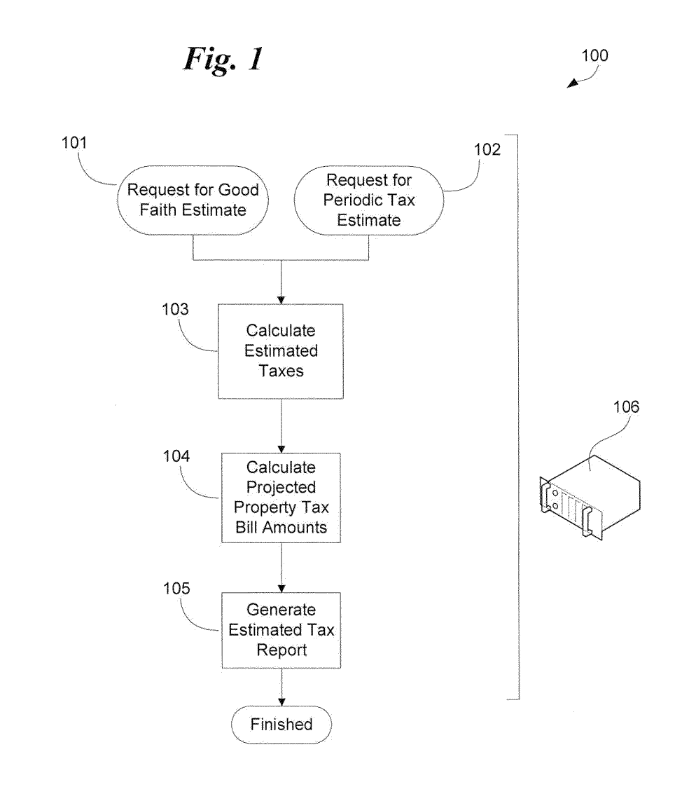

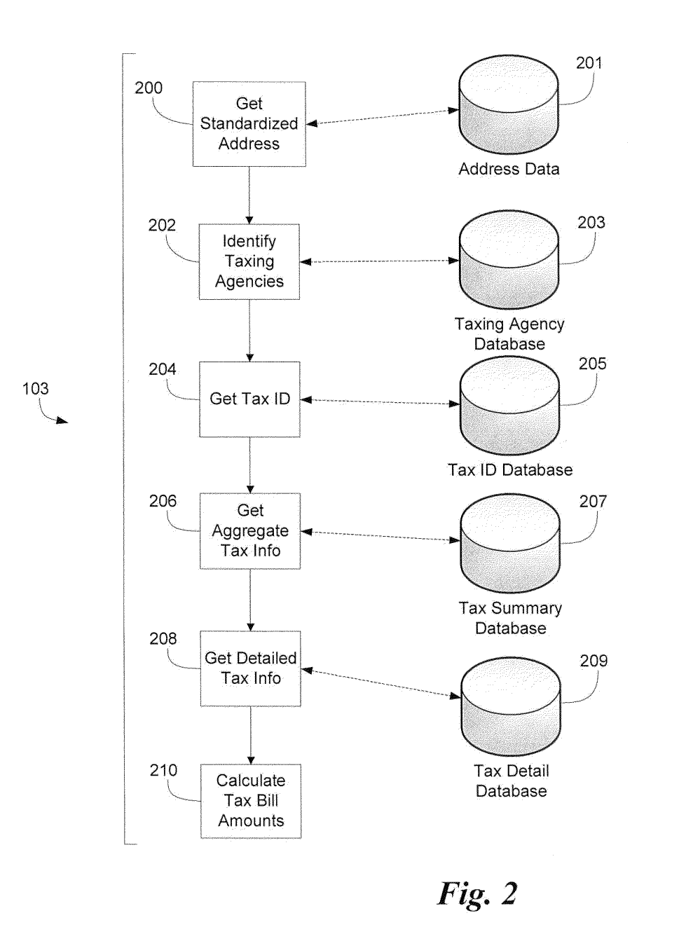

Reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will first appear in FIG. 1, an element identified by a “200” series reference numeral will first appear in FIG. 2, and so on.

Disclosed is a computer implemented system for calculating estimated property payment amounts. The system assembles detailed tax information for a particular property and categorizes this detailed tax information into “variable”, “fixed”, and “one-time” tax levies or tax bill amounts. These distinctions aid the system in calculating projected or estimated tax bill amounts for a particular future time period.

For example, variable tax levies include past tax bill amounts which relate to the past assessed values of property. Therefore the system can use these variable levy amounts along with prior assessed values to calculate a variable levy tax rate. This levy tax rate can then be used to predict future variable levy amounts based on the new assessed value or purchase price.

The system may also add together all the fixed category levies to provide a fixed levy amount. Fixed levies generally do not vary with the value of the property and also generally appear on a recurring basis. The fixed levies on the existing bill can therefore be used to estimate future tax bill amounts. For example, future fixed levies can be predicted by adding together past fixed levy amounts to arrive at a predicted total fixed levy amount.

One-time levy amounts include one time charges that may not be carried forward into the estimated tax bill amount because they arise from particular events occurring in the past that may be too unpredictable to include in future estimates. The system may calculate and include estimated tax amounts for levies that recur infrequently, yet in a semi-predictable pattern, or for a predetermined number of tax cycles before terminating. Such levies may appear infrequently based on the property owner's request, or when the municipality deems the expenditure necessary, with the result being additional charges in an infrequent or irregular pattern over time.

The newly estimated total property tax bill amounts can then be used to predict future tax payments. These tax payment predictions may be useful for a variety of users or consumers such as new home buyers, property owners, banks, or mortgage companies to name a few examples. For example, new home buyers can better budget future total monthly house payments, of which property taxes may only be a portion. In another example, banks, mortgage servicers, or current property owners can benefit as well because in some jurisdictions, tax data may be available weeks or months ahead of property tax payment deadlines or official notifications making it possible to plan for any estimated changes in property taxes due well in advance of official due dates.

FIG. 1 illustrates at 100 one example of a sequence of operations useful for implementing the disclosed property tax estimation procedure. The system may be useful for calculating estimated property tax bill amounts for a wide range of scenarios such as when an event occurs that triggers a property value reassessment as required by local laws or ordinances. Examples of such triggering events may include a transfer of ownership of one or more property interests, or refinancing the property. For example, an estimate of future property tax bill amounts may be included along with the good faith estimate 101 provided to the real estate purchaser buying a building, land, or other real estate.

Property tax estimation system 100 may be useful in contexts that do not involve triggering events. In one example, a property owner, a mortgage company, the owner, or an agent operating on the owner's behalf, may request a property tax estimate periodically (at 102) ahead of a scheduled property tax bill amount to determine whether and how much property tax bill amounts are likely to change. In one example, a bank or mortgage company may request a periodic property tax estimate 102 in advance of upcoming property tax bill amounts in order to determine if additional escrow payments should be requested from the property owner to meet any projected new tax obligations. Property tax estimation system 100 may also be used in other scenarios, such as by governmental agencies or taxing authorities seeking to predict changes in revenue resulting from changes to existing tax laws.

System 100 operates on a computer 106 having a processor, memory, and possibly various other components discussed in greater detail below as well as access to one or more databases useful for retrieving and storing information pertinent to the process of estimating property taxes. System 100 uses the processor to calculate estimated tax amounts 103, calculate projected property tax bill amounts 104, and to generate an estimated tax report 105. The generated tax report may be useful for a variety of purposes. For example a report may be incorporated with a good faith estimate, or used by the property owner or agent representing the property owner to budget for increased or decreased future tax bill amounts.

Address, tax ID, parcel number, owner name, or any other information useful for estimating future tax bill amounts can be provided to system 100 in various. For example, a mortgage broker, bank employee, property owner, or other user may enter information included in a property tax estimate request sent to system 100 using an interface such as a graphical user interface appearing on a display coupled to computer 106. In another example, the interface may be provided by computer 106 to another computer or terminal, such as in the form of electronic signals over a network that can be decoded and rendered as a web page or other user interface. Such an interface may then be configured to appear on a second display coupled to a second computer or terminal connected to system 100. In another example, the interface may include an electronic data exchange system where the information is encoded in a machine readable format, sent to or from computer 106 over a network interface connected to a network such as the internet. This exchange may occur as part of requesting a good faith estimate (at 101) or a periodic tax estimate (at 102), with the data being decoded by computer 106 or another computer for processing. In one example, this electronic data exchange may take place by encoding the information using the Extensible Markup Language (XML). In another example, the electronic data may be exchanged using a spreadsheet file, a text file, a binary data file, a local or remote data exchange directly between two or more relational databases, or using any other suitable electronic form.

The exchange of data at 101 or 102 may occur as part of a manual process initiated for individual properties by a mortgage broker, bank employee, property owner, or other user, or may be initiated as part of an automated process whereby numerous requests for property tax estimates are calculated for corresponding collections or batches of properties without manual intervention. Where multiple estimations are performed for corresponding multiple properties, manual intervention by a system user may only occur where necessary, such as when a particular data field is required and is blank, includes invalid characters, is above a predetermined maximum or below predetermined minimum value, or is otherwise outside predetermined validity thresholds.

FIG. 2 illustrates further detail including exemplary actions that may be taken by the processor in the calculation of estimated tax amounts 103. The processor may, for example, be programmed to obtain a standardized address for the property of interest 200 from an address database 201. The process of obtaining a standardized address may include querying a local or remote database of address data possibly provided by a third-party vendor. Obtaining a standardized address 200 may also include the processor or the address database 201 performing a validation procedure for automatically validating and updating or editing the supplied address to remove inconsistencies in the content or format of the address information.

The property address can be used by the system to identify one or more taxing agencies 202 which, in one example, is determined based on the county the property is located in. Other examples may include additional taxing authorities such as municipalities, townships, or in some cases perhaps a state or federal taxing agency. Additional taxing authorities may also be involved in situations where the property crosses a boundary between two or more taxing authorities.

Using the standardized address from address database 201, the taxing agency can be determined by querying a taxing agency database 203. In one example, the taxing agency database transforms the address to a geographic location such as a latitude and longitude, and determines which of over 20,000 local taxing agencies contains the supplied address. Querying taxing agency database 203 may also include comparing the latitude and longitude against a map or 2-dimensional polygon reference data stored for each taxing agency in a taxing agency database 203.

Using the one or more taxing agencies from taxing agency database 203, the system may obtain a tax ID 204 from a tax ID database 205. The tax ID from the tax ID database 205 can then be used to obtain summary aggregate tax information at 206 from a tax summary database 207. The tax summary database 207, in one example, is remotely available from a federal or state agency or other similar government taxing authority through a network such as the internet or similar computer network. The tax ID from database 205 can also be used by the processor to retrieve a similarly available collection of detailed tax info at 208 from a tax detail database 209. This detailed information can be an itemized list of individual tax line items or tax levies corresponding to the various relevant taxing authorities for the property of interest. Access to the tax summary database 207, or the tax detail database 209 may be provided by a government agency or by a private third party.

The various detailed tax levies are used by the processor to calculate estimated tax bill amounts at 210 for inclusion in the report 105. This can result in a projected increase or decrease in property tax bill amounts.

System 100 may also be configured to allow users to engage the process of calculating estimated tax bill amounts 103 in other ways. For example, for users who already know the taxing agency for a given property, system 103 may provide access to skip the functionality included in obtaining a standardized address at 200 and identifying the tax agency at 202. Similarly, a user may know the tax ID for a given property or have already obtained the tax IDs for a batch of properties. In that case, system 100 may allow the user to move directly to obtain aggregate tax information at 206 rather than moving through the actions illustrated at 200, 202, and 204. System 100 may also be implemented as an Application Programmer Interface (API), or using a Service Oriented Architecture (SOA) where users may access any of the behavior illustrated at 200, 202, 204, 206, 208, or 210 as function calls or requests to a web service or similar system. For example, an interface running on computer 106 or on another computer connected to system 100 by a computer network such as the internet my be configured to call an API or SOA to recalculate or refresh a previously estimated tax bill amount or amounts using taxing agency, parcel, and other information previously retrieved by system 100 at 200, 202, and 204. In this example, the interface may allow the interface to use an API, SOA, or other similar direct access to system 100 functionality to initiate a request for aggregate tax information (at 206), detailed tax info (at 208), or a tax bill amount estimate (at 210) depending on what data is to be refreshed. Thus the processes involving obtaining estimated tax calculations may occur in any suitable order, including, but not limited to, the sequence illustrated in FIG. 2.

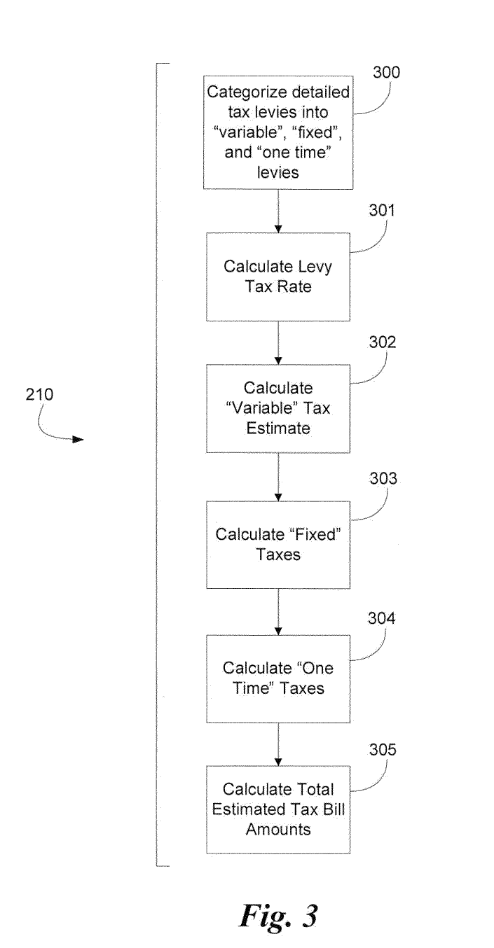

Further detail of one example of actions that may be taken in the calculation of tax estimates 210 is shown in FIG. 3. The processor uses the detailed tax information retrieved at 208 to categorize the detailed tax levy information 300 from the tax detail database 209. The processor compares the detailed tax info to a number of classification rules to categorize the detailed tax info into “variable”, “fixed”, and “one-time” tax levies.

In the illustrated examples, variable levies may be based solely or in part on the value of the particular property. In one example, a variable basic levy is applied against all property and the levy is equal to one percent (1%) of the assessed value. Also included in these variable levies are debt levies such as bond measures added by various ballot initiatives passed by local voters for funding various projects such as roads, bridges, schools, and the like, or for funding general operating expenses. In one variable levy categorization example, the assessment types included with each entry in the detailed tax information are compared to a processing rule that is satisfied when the assessment type includes particular key words such as “Proposition 13”, “Proposition 8”, or “General Obligation Bonds” corresponding to known bond initiatives or other tax levies related to property value. In another example, a variable categorization processing rule may be satisfied when the assessment type simply includes key words like “proposition” or “bond” in any form. In yet another example, a categorization rule may only be satisfied for those entries having one or more predetermined “tags” or “flags” indicating they are “variable” entries.

The itemized detailed tax info may also include fixed levies that are not based on the property value. These tax line items may be flat rate recurring tax levies based on a particular benefit to the property regardless of property value such as street sweeping, maintenance of common areas such as parks and beaches, or maintenance of flood control systems.

The taxing authority may also levy one-time taxes for a particular property for specific reasons. For example, the charges may result from penalties or restorative action required for the property such as a charge for being delinquent in trash removal, failing to properly maintain buildings or property, storing hazardous waste on the property for some period of time, or charges related to violating other public ordinances. Other examples of one-time tax levies may include assessments for improvements made to the property, or for one-time maintenance to the property such as local disaster clean up or repairs. One example of a classification or categorization rule that may be used for determining one-time tax levies is a rule that is satisfied when the assessment type includes the keywords “unabated” or “delinquent” in any form. Detailed tax info data entries satisfying this rule are categorized as “one-time” levies and may be ignored (i.e. filtered out) by the system in making property tax estimates because they were amounts charged in response to particular situations that likely will not recur with predictability.

The system may also include in the estimated tax amount levies categorized as either “fixed” or “one-time” levies which occur infrequently or in an irregular yet semi-predictable pattern, or for a predetermined number of tax cycles before terminating. The system may then calculate an estimated average fixed levy that takes these levies into consideration as well. For example, an attachment to a local municipal water or sewer system may include a predetermined levy that is fixed but maintained for only a predetermined period of time (e.g. 10 years) before expiring. In another example, a local municipality may levy a tax for properties bordering a lake or storm drain creek or swale for costs associated with cleaning the drain or removing vegetation or particular pests from the lake. Such a levy may appear only when the municipality deems the procedures necessary, but results in additional yet semi-predictable charges in an irregular pattern over time.

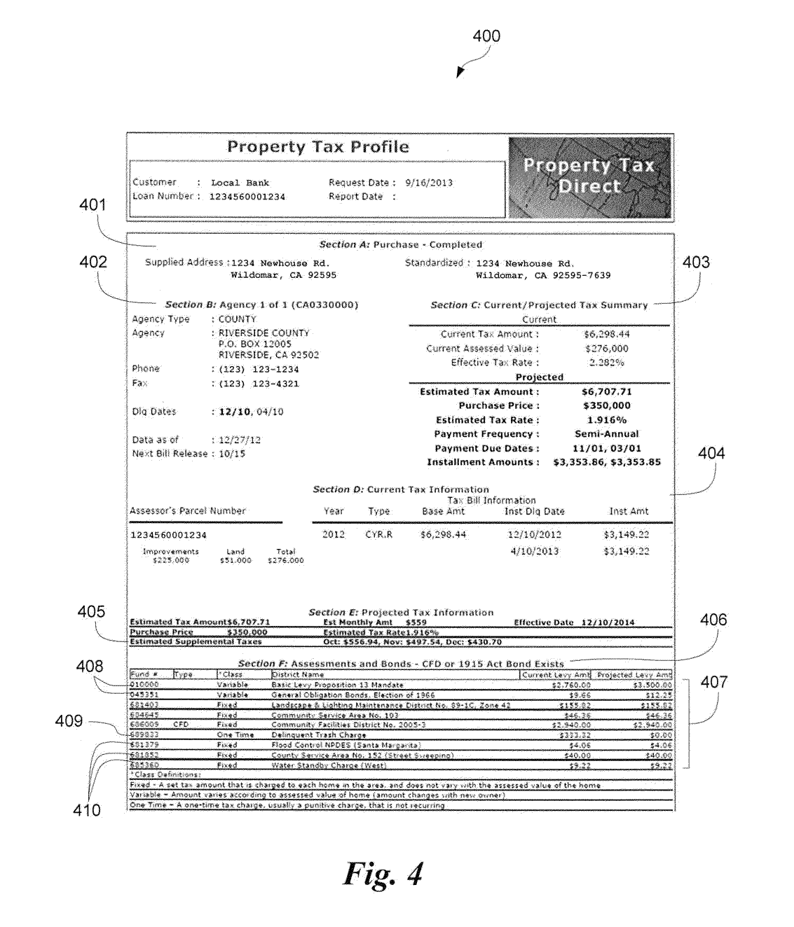

The processor may use the variable, fixed, and one-time categories to calculate a total estimated tax. For example, the system may calculate the variable tax estimate by calculating a variable levy tax rate 301 based on previous variable levies and the previously assessed value. The variable levy tax rate may be calculated by dividing the sum of the variable tax levies by the previously assessed value, yielding a variable levy tax rate as a percentage. This variable levy tax rate may then be multiplied by the current value under consideration to calculate the new variable tax estimate 302. The current value under consideration may for example, be a new purchase price for the property, or it may be a new or hypothetical assessed value that is higher or lower than the current assessed value. In this way, previous tax amounts based on property value can be used to determine a component of the overall estimated tax amount that is based on the new value. The individual variable levy rates can also be included in an itemized or detailed listing as well to indicate how the variable tax estimate was calculated at 302. Examples of these appear in FIG. 4 and are described in greater detail below.

Fixed category tax levies can also be used to calculate a fixed tax levy 303. In one example, the total fixed tax levy is calculated by summing together all of the individual fixed tax levies. This carries forward into the new estimate all of the flat-rate tax amounts that have been regularly applied to the property in the past.

Similarly, the one time total tax levy may be calculated 304 by ignoring one-time charges related to unpredictable events, while summing together all of the known one time future tax charges which appear in a semi-predictable pattern. The processor may calculate a total estimated tax amount 305 by adding together the variable tax estimate calculated at 302, the fixed tax estimate calculated at 303, and the one-time tax estimate calculated at 304.

Having calculated total estimated taxes, system 100 may use the processor to calculate projected property tax bill amounts 104 and optionally to determine a payment strategy suitable for meeting any projected changes to existing tax obligations. In one example, projected property tax bill amounts are determined by calculating the additional payment amount and simply dividing the additional payment amount by the number of months remaining until the next tax bill amount is due. In another example, the processor may apply a weighting factor to the calculation, for example, to make the additional payment amounts higher at first, tapering off as the payment due date approaches. In some cases it may be advantageous to the property owner, bank, or escrow agency for property tax estimation system 100 to calculate a payment schedule where more than one additional payment is scheduled in some months and not others.

In cases where previous tax bill amounts have been made into an escrow account as part of a monthly mortgage payment, the bank, mortgage company, or other responsible intermediary may incorporate the calculated payment schedule by adjusting the preexisting schedule of regular mortgage payments. In this way, the projected change to the property tax amounts calculated by system 100 can be incorporated into the current payment stream providing a more gradual budgetary adjustment for the property owner who must meet an estimated new property tax obligation. If, for some reason, the new tax estimate is higher than the tax amounts actually levied, the hank or mortgage company, for example, may either apply the excess amount to future tax bill amounts, or refund the excess amount back to the property owner.

In another example where no escrow account is being used to manage property tax bill amounts, the property owner or other responsible party may choose to proactively make the projected additional payments in advance of the due date. System 100 can provide a suggested payment strategy indicating the suggested payment plan to the property owner. In another example, the property owner may implement the suggested payment plan by setting aside the amounts suggested until the due date arrives, at which time the set-aside funds can be used to pay the new levy once it is known.

Having calculated the individual variable, fixed, and one-time tax levies as well as determining a plan for paying the estimated change in tax bill amounts, system 100 can generate an estimated tax report 105 detailing some or all of this information. One example of an estimated tax report is illustrated in FIG. 4 at 400. Property tax report 400 includes sections containing much of the data discussed above. For example, address information 401 includes the original address provided as well as the standardized address received after obtaining address data from database 201. Taxing agency information 402 provides contact information for the local taxing agency which in this example is a county. A projected tax summary 403 provides current and projected tax information including an effective tax rate and a projected effective tax rate as well as newly calculated estimated installment amounts.

Current tax information 404 shows the base tax amount on the current tax bill as well as the current installment amounts. Further detail of projected tax information is shown in projected tax information 405. For example, 405 shows an estimated monthly tax total as well as estimated supplemental taxes along with an effective date.

The detailed tax levy information 406 is illustrated in tabular form in report 400 where the detailed tax levy data entries 407 from tax detail database 209 are listed as individual line items. Examples of variable 408, fixed 410 and one-time 409 levies are also illustrated in the listing as well. Variable levies shown at 408 include a “Proposition 13” basic levy and a “General Obligation” levy, both of which are used as described above to calculate a variable levy rate and a resulting projected levy amount. Fixed levies 410 include levies for flood control, street sweeping, and landscape and lighting maintenance. These also are carried forward into the projected amount because they likely will appear in future tax bills, and likely will not change in response to a change in property value. One-time levy 409 for a “delinquent trash charge” is a charge that appears in response to a particular situation that occurred in the past and is unlikely to recur in a predictable or semi-predictable pattern in the future. Therefore the one-time levy in this example is ignored.

A report format may also be useful which may include more or less data or other individual data points depending on whether the report is intended to be included in a good faith estimate, used to determine adjustments to escrow withholdings or taxpaying thus to an existing property, or for some other similar purpose related to property tax calculations. In another example, the report data fields discussed above may be encoded in a machine-readable format such as XML and transmitted to another system either operating on computer 106 or operating remotely on a separate computer system accessible via a network such as the internet where the data may be rendered in a different layout or format.

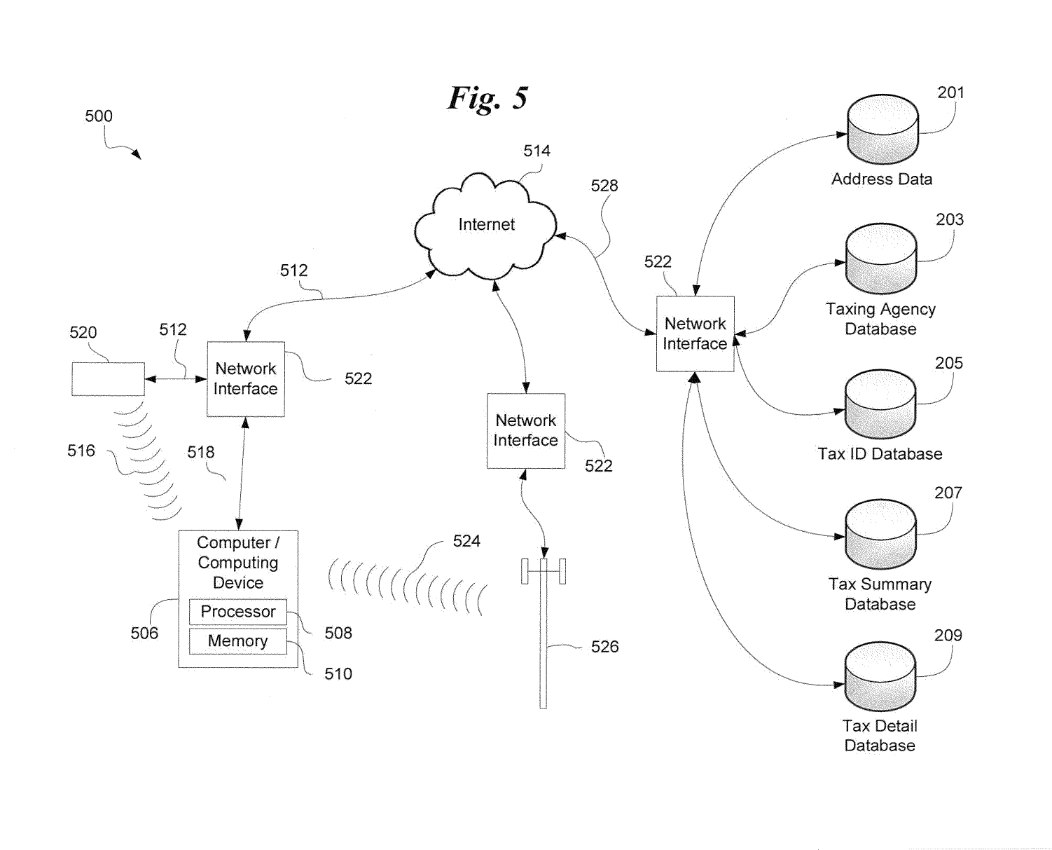

Considering further the implementation specifics illustrated in FIG. 5, the system is illustrated at 500 as capable of operating as software executing on computer 106 which is further illustrated in FIG. 5 is computer 506. Computer 106 (and 506) may include one or more processors or CPUs 508 and one or more types of memory 510. Each memory preferably includes a removable memory device. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM, i3, i5 or i7 processors supplied by INTEL Corporation of 2200 Mission College Boulevard, Santa Clara, Calif. 95052, USA.

Each memory (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Computer 106 represents a “computer” in the generic sense and may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a network 512. Network 512 may also be connected to a wider network such as the internet 514. Thus computer 106 may be composed of one or more physical computing devices having one or more processors and memory as described above.

Computer 106 may also include a virtual computing platform having an unknown or fluctuating number of physical processors and memory devices supporting the operation of the systems described above. Likewise, computer 106 may be located in one geographical location or spread across several widely scattered locations with multiple processors linked together to operate as a single computer connected by a network. Just as the concept of a computer is not limited to a single physical device, so also the concept of a “processor” is not limited to a single physical logic circuit or package of circuits but includes one or more such circuits or circuit packages possibly contained within or across multiple computing machines in various physical locations.

The concept of “computer” and “processor” within a computer or computing device also encompasses any such processor or computing device serving to make calculations or comparisons as part of disclosed system. Processing operations related to threshold comparisons, rules comparisons, calculations, and the like occurring in computer 106 may occur, for example, on separate servers, the same server with separate processors, or on a virtual computing environment having an unknown number of physical processors as described above.

In one embodiment, computer 106 is coupled to a display and/or includes an integrated display. Likewise, displays may be of the same type, or a heterogeneous combination of different visual devices. Although not shown, each computer may also include one or more operator input devices such as a keyboard, mouse, touch screen, laser or infrared pointing device, or gyroscopic pointing device to name just a few representative examples. Also, besides a display, one or more other output devices may be included such as a printer or plotter. As such various display, input and output device arrangements are possible.

Computer 506 may be configured to communicate over wired network connection 518, or over radio signals 516 to a WLAN (or WiFi) transceiver 520. These network communications may pass through a router or firewall or other network interface 522 before passing over a larger computer network or series of computer networks such as the internet 514. Communications can also be passed over the network as wireless data transmissions carried over signals 524 exchanged with a cellular transmitter/receiver 526 which can be passed through a network interface 522. Signals 526 may conform to any of a number of mobile telecommunications technology standards such as 3G, 4G, and the like.

The data and operating logic of the system described above can be embodied in signals transmitted over network 512 and/or internet 514 in programming instructions, dedicated hardware, or a combination of these. The network may include a wireless connection 516 to a Local Area Network (LAN), Municipal Area Network (MAN), or Wide Area Network (WAN). The network may also include wireless connections to a, such as the internet 514, a combination of these, or any other suitable network connection.

External data sources, some of which are illustrated in FIG. 2, may also be connected to or included in the system via data access devices connected to these same communications links, or by data access devices may provide data by other means such as via nonvolatile storage devices such as DVD or CD-ROM, flash memory devices, and the like. As illustrated in FIG. 5, databases 201, 203, 205, 207, 209 may be accessible over network 528 which can be coupled to the internet 514. Computing device 506 and databases 201, 203, 205, 207, 209 can communicate with each other by controlling the intervening networks and network interfaces to send and receive requests, queries, data, information and the like. The illustrated databases may communicate with internet 514 over network 528 using network interface 522 or by any other suitable network communication system. For example, the illustrated databases may communicate through a wired connection or through wireless signals like signals 516 or 524. The illustrated databases may also be operated on separate single computers or computing device remote from one another, as virtual databases operating on a varying number of computing devices, from within a single database instance operating on a single computing device, or any suitable combination thereof.

Users may also interact with the system by submitting requests for property tax estimation over the same networks or by receiving the resulting property tax estimation reports by nonvolatile copies or by other means. It shall be appreciated that in alternate forms a user may submit requests and view reports generated by the system as well as other relevant property tax information on computing devices such as a PDAs, Blackberries, iPhones, iPads, smart phones or tablet computers, to name just a few illustrative examples.

In one embodiment, users interact with the system via one or more software applications operating on computer 106 which serves HTML pages, sends and receives data via web services, and/or other Internet standard or company proprietary data formats, or maintains dedicated client/server connections in order to facilitate the transfer of information between the user and the system, or between the system and outside data sources. As described above, this interaction can take place over any of the illustrated networks or over another suitable electronic communications network. Further, it shall be appreciated that the types of communication methods connected within the above described system need not be of the same type, but that digital, analog, and other technologies may be accommodated simultaneously.

While the illustrated embodiments have been detailed in the drawings and foregoing description, the same is to be considered as illustrative and not restrictive in character, it being understood that only the preferred embodiment has been shown and described and that all changes and modifications that come within the spirit of the invention are desired to be protected. The articles “a”, “an”, “said” and “the” are not limited to a singular element, and include one or more such elements.

What is claimed is:

1. A method of calculating future property taxes comprising:
accepting a request to calculate property taxes for a real estate property with a new property value, the new property value associated with a triggering event requiring a recalculation of a property tax schedule for the real estate property, wherein the real estate property is identifiable by a tax ID, wherein the request is accepted by a processing computer coupled to a communications network, the processing computer having a processor and memory and controlling the communications network to receive the request;
controlling the communications network to retrieve tax detail information about previously paid tax levy amounts associated with the real estate property at a past property value, wherein the processing computer controls the communications network to retrieve the tax detail information from a tax detail database over the communications network;
comparing the tax detail information about the tax levy amounts with one or more classification rules to classify the tax detail information into variable tax levies, fixed tax levies, past one-time tax levies and known future one-time tax levies using the processor;
using the processor to calculate applicable tax percentage rates for the one or more variable tax levies using the past variable tax levy amounts paid and the past property value associated with the real estate property;
using the processor to apply the calculated applicable tax percentage rates to the new property value to calculate estimated new variable tax levy amounts, and using the processor to calculate a new property tax payment schedule associated with the new property value including the new variable tax levy amounts, the fixed levy amounts and known future one-time levy amounts; and
controlling the communications network to send an estimated taxes report corresponding to the request for estimated taxes, wherein the processing computer includes the new property tax payment schedule, and the new variable, fixed, and one-time tax estimates in the report, and wherein the processing computer controls the communications network to transmit the estimated taxes report from the processing computer over the communications network.

2. The method of claim 1, wherein the triggering event is any one of a transfer of ownership of one or more property interests of the real estate property, a refinancing of the real estate property, or a new assessment of the value of the real estate property.

3. The method of claim 1, comprising:
controlling the communications network to retrieve summary aggregate tax information for the real estate property, wherein the processing computer controls the communications network to retrieve the summary aggregate tax data from a tax summary database over the communications network.

4. The method of claim 1, comprising:
controlling the communications network to retrieve the tax ID associated with the real estate property using tax agency information corresponding to one or more taxing agencies responsible for levying taxes in the past for the real estate property, wherein the processing computer controls the communications network to retrieve the tax ID from a tax ID database.

5. The method of claim 4, comprising:
controlling the communications network to retrieve the tax agency information corresponding to the one or more taxing agencies using standardized address information identifying the address of the real estate property, wherein the processing computer controls the communications network to retrieve the tax agency information from a tax agency database.

6. The method of claim 5, comprising:
controlling the communications network to retrieve the standardized address information identifying the address of the real property using input received by the processing computer, wherein the processing computer controls the communications network to retrieve the standardized address information from a standardized address database.

7. The method of claim 6, wherein the tax summary database, the tax detail database, the tax ID database, the tax agency database, and the standardized address database are separate databases.

8. The method of claim 6, wherein the the tax detail database, the tax ID database, the tax agency database, and the standardized address database are remote from each other, and remote from the processing computer.

9. The method of claim 1, wherein the processing computer is configured to send the estimated property taxes report after receiving a request for a tax estimate for the real estate property.

10. The method of claim 1, wherein the processing computer is configured to create the estimated property tax report after receiving a request for a good faith estimate for the real estate property.

11. The method of claim 1, comprising:
using the processing computer to control the network to send the new property tax payment schedule to a lender, wherein the lender uses the new property tax payment schedule to create or modify payment terms for a pending or future loan for the real estate property.

12. A method of calculating future property taxes comprising:
receiving a request for estimated property taxes for a real estate property with a new property value and identified by a tax ID, wherein the request is received by a processing computer having a processor, the processing computer configured to receive requests for estimated taxes through a communications network;
retrieving aggregate tax information for the real estate property from a tax summary database using the tax ID, wherein the tax summary database is remote from the processing computer and the processing computer communicates through the communications network;
retrieving tax detail information for the real estate property from a tax detail database using the tax ID, wherein the tax detail database is remote from the processing computer, and the processing computer communicates through the communications network;
using the processor to classify the tax detail data into variable, fixed, or one-time tax levies using one or more classification rules;
calculating a variable tax percentage rate using the variable tax levy amounts and a previous property value associated with the real estate property using the processor;
calculating predicted future variable tax estimate amounts by applying the calculated variable tax percentage rate to the new property value using the processor;
determining predicted future fixed and one-time tax estimated amounts by using the processor to determine the fixed and a one-time tax levies that will be applied in the future;
using the processor to calculate future property tax estimated amounts using the predicted future variable tax estimated amount, and the predicted future fixed and one-time tax estimated amounts;
calculating a property tax payment schedule using the processor, wherein the tax payment schedule includes the predicted future variable, fixed, and the one-time tax estimated amounts; and
creating an estimated property tax report using the processing computer, the processing computer using the property tax payment schedule and the aggregate tax information.

13. The method of claim 12, wherein the request for estimated property taxes for the real estate property is received by the processing computer after a triggering event has occurred requiring a recalculation of the property tax schedule, wherein the triggering event is any one of a transfer of ownership of one or more property interests of the real estate property, refinancing of the real estate property, or an assessment of the value of the real estate property.

14. The method of claim 12, comprising:
retrieving the tax ID associated with the real estate property using tax agency information corresponding to one or more taxing agencies responsible for levying taxes in the past for the real estate property, wherein the processing computer uses the tax agency information to retrieve the tax ID from a tax ID database.

15. The method of claim 14, comprising:
retrieving the taxing agency information identifying one or more taxing agencies from a taxing agency database using the processor, the taxing agency database accessible through the communications network;
wherein the taxing agency information is associated with the real estate property by a standardized address for the real estate property.

16. The method of claim 15, comprising:
retrieving the standardized address from an address database accessible through the communications network using the processor, the address database having address data for the real estate property that includes the standardized address.

17. The method of claim 12, wherein the processing computer creates the estimated property tax report after receiving a request for a tax estimate for the real estate property.

18. The method of claim 12, wherein the processing computer creates the estimated property tax report after receiving a request for a good faith estimate for the real estate property.
